(19) United States
(12) Patent Application Publication
(10) Pub. No.: US 2016/0032889 A1
(43) Pub. Date: Feb. 4, 2016

(54) SUSTAINABLE HYBRID RENEWABLE ENERGY SYSTEM

(71) Applicants: Ting Tan, Shelburne, VT (US); Tian Xia, South Burlington, VT (US)

(72) Inventors: Ting Tan, Shelburne, VT (US); Tian Xia, South Burlington, VT (US)

(21) Appl. No.: 14/816,015

(22) Filed: Aug. 2, 2015

Related U.S. Application Data
(60) Provisional application No. 62/032,559, filed on Aug. 2, 2014.

(51) Int. Cl. F03D 3/06; F03D 9/02; F03D 11/00

(52) U.S. Cl. CPC F03D 3/061; F03D 3/065; F03D 11/0041; F03D 11/0091; F03D 9/021

(57) ABSTRACT

A vertical wind turbine having a plurality of blades having an aerodynamic helix core laminated with natural bamboo is provided. Each blade with its aerodynamic core laminated with natural bamboo also includes: a framework which is resistant to stress fractures and minimizes or eliminates traveling stress concentrations. The hybrid helical blade construction includes honeycombed ABS plastic core which provides superior lightweight mechanical strength.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith: the present application also claims the earliest available effective filing date(s) from and also incorporates by reference in its entirety all subject matter of any and all parent, grandparent, great-grandparent, etc. applications of the Related Application(s) to the extent such subject matter is not inconsistent herewith:

U.S. provisional patent application 62/032559 entitled “A Hybrid Renewable Energy system”, naming Ting Tan as inventor, tiled 2 Aug. 2014.

### BACKGROUND

1. Field of Use

The present invention relates to a reinforced bamboo blade for an aesthetic hybrid renewable energy system including solar and wind turbine power generation. The wind turbine power generation particularly having vertical blades having computer generated helical cores laminated with natural bamboo in order to prevent deformation of the blade and provide natural aesthetics.

2. Description of Prior Art (Background)

In a wind turbine, the momentum of the wind is converted into rotary energy, which is used to turn a generator shaft to create electric current, The two main types of wind turbines are the horizontal-axis wind turbine (HAWT) and the vertical axis wind turbine (VAWT). Both HAWT and VAWT designs use either or both of two aerodynamic forces—drag and lift—to create torque on the generator shaft In lift-based designs, the blades typically have an airfoil shape, so that, like an airplanes wing or a sailboat's sail, it “flies” at an angle toward the wind. In a horizontal-axis wind turbine, a propeller is mounted on a supporting, structure such as a tower and rotates about a horizontal shaft, which is typically linked with the generator shaft via a gearbox. Since the direction of the wind will normally change, the propeller as a whole must be able to rotate about a vertical axis in order to face the wind and have the greatest possible efficiency. This creates problems of balance and wear on the bearings that allow the propeller to swivel around the vertical axis, especially since the generator is typically also mounted at the top of the supporting structure must rotate with the propeller. In a vertical-axis wind turbine (VAWT), blades of the turbine are arranged substantially vertically, and they rotate about a vertical axis which is either also the axis of rotation of the generator shaft or is linked via a gear train to the generator shaft.

A major advantage of VAWT designs is that they do not require any re-orientation when the wind changes directions. Typically, a wind turbine blade has an aerodynamic shell and a girder, such as a beam or a spar. The girder can be a single beam, but often two girders are used. The two girders together with the parts of the shell extending between the two girders form a so-called box profile. The top and bottom of the box profile are often referred to as the caps. Some types of blades are designed with a spar in the form of a box like profile which is manufactured separately and bonded in between prefabricated surface shells. Typically, the aerodynamic shell is made from two shell parts that are assembled to form the shell.

Under normal operating conditions, the wind turbine blade is subjected to loads at an angle to the flapwise direction. It is common to resolve this load on the blade into its components in the flapwise and edgewise direction. The flapwise direction is a direction substantially perpendicular to a transverse axis through a cross-section of the blade. The flapwise direction may thus be construed as the direction, or the opposite/reverse direction, in which the aerodynamic lift acts on the blade. The edgewise loads occur in a direction perpendicular to the flapwise direction. The blade is further subject to torsional loads which are mainly aerodynamic and inertia loads. These loads can subject the blade to harmonic motions or oscillations at the blade's torsional Eigen-frequency.

When a blade is subjected to edgewise loading the section of the shell between a trailing edge of the blade and the internal girder is deforming out of the plane of the “neutral” (or initial) plane of the surface. This deformation induces peeling stresses in the trailing edge of the blade and consequently this can lead to a fatigue failure in the adhesive joint of the trailing edge where the two shell parts are connected to each other.

Furthermore, the deformation of the shell can lead to deformations in both the shell and the girder at the connection and this can lead to fatigue failure of the girder and/or fatigue failure of the shell and/or fatigue failure in the connection between the girder and the shell.

The fatigue failure in the trailing edge, the shell, girder or the connections may then ultimately cause the blade to break apart. The deformation can also lead to buckling of the shell and this reduces the ultimate strength of the blade because the shell is load bearing. Furthermore, the deformations also compromise the aerodynamic efficiency of the blade since the designed shape of the blade profile is no longer maintained.

The edgewise loads can further cause the trailing edge of the blade to deform in a stable post buckling pattern. This is caused by bending of the blade from the leading edge towards the trailing edge. The blade material in the leading edge is then subject to tension and the trailing edge to compression. Since the trailing edge is relative thin, it cannot withstand substantial compression forces before it bends out of its neutral plane. When this happens, some of the load on the trailing edge is transferred to and distributed through part of the shell further away from the trailing edge, until equilibrium of the forces is established. Although this deformation does not immediately lead to failure, it decreases the safety margin for the general failure load of the blade and also increases the peeling and shear stresses in the trailing edge.

Subjected to flapwise loads, the section of the aerodynamic shell between the trailing edge and the internal girder is deforming out of the plane of the surface's “neutral” position in a similar way as described above for the edgewise loads. This deformation also induces shear and peeling stresses in the trailing edge of the blade. The section will deform into a state of “lowest energy level”, i.e. a situation wherein as much as possible of the stress in the blade is distributed to other sections of the blade, When part of the shell deforms in this manner, it is usually referred to as an “ineffective panel”. The distribution of the stresses to other parts of the blade means that these parts are subjected to a higher load. This will result in a larger tip deflection of the blade. Furthermore, the deformations of the blade's surface compromise the aerodynamic efficiency of the blade, because the designed shape of the profile is no longer maintained.

Thus, there is a need for a vertical axis wind turbine in which deformations of the blade are prevented or minimized and wherein the blade structure is strengthened without increasing the overall weight.

### BRIEF SUMMARY

The foregoing and other problems are overcome, and other advantages are realized, in accordance with the presently preferred embodiments of these teachings.

In accordance with one embodiment of the present invention a method for combining wind generated and solar power is provided.

The invention is also directed towards an aesthetic vertical wind turbine having a plurality of blades. Each of the blades include an aerodynamic helix core laminated with natural bamboo. Each blade with its aerodynamic core laminated with natural bamboo also includes: a framework which is resistant to stresses and minimizes or eliminates traveling stress concentrations. The hybrid helical blade construction includes honeycombed ABS plastic core Which provides superior lightweight mechanical strength. The ABS plastic COM is honeycombed with fracture reducing holes to reduce or stop possible traveling stress fractures. The helical skeleton core, combined perpendicular with the inherent mechanical features of the bamboo, permit thinner, stronger and/or flexible blades than blades described, in the prior art. In addition, an epoxy for binding bamboo and plastic core can be bio compatible epoxy.

The hybrid system (solar and wind) disclosed herein may include passive and/or active sensors/transducers on the blades. The sensors/transducers (e.g., acoustic, optical, ultrasound, ultraviolet) can be used to warn or deter. For example, acoustic generators can be used to warn animals such as bats or eagles. The hybrid system also includes slip ring contacts for powering sensors/sensors transducers.

### BRIEF DESCRIPTION OF THE DRAWINGS

FIG. 1 is a schematic illustration of a hybrid renewable energy system with a vertical-axis wind turbine (VAWT) with “twisted” blades according, to the invention;

FIG. 2 illustrates a top down blade/hub configuration in the VAWT according to the invention:

FIG. 3 is a partial exploded view of the twisted blades in accordance with the invention shown in FIG. 1.

FIG. 3A is a partial exploded view of an alternate core shape; and

FIG. 4 is a partial sectional view of the twisted blades in accordance with the invention shown in FIG. 1.

### DETAILED DESCRIPTION

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

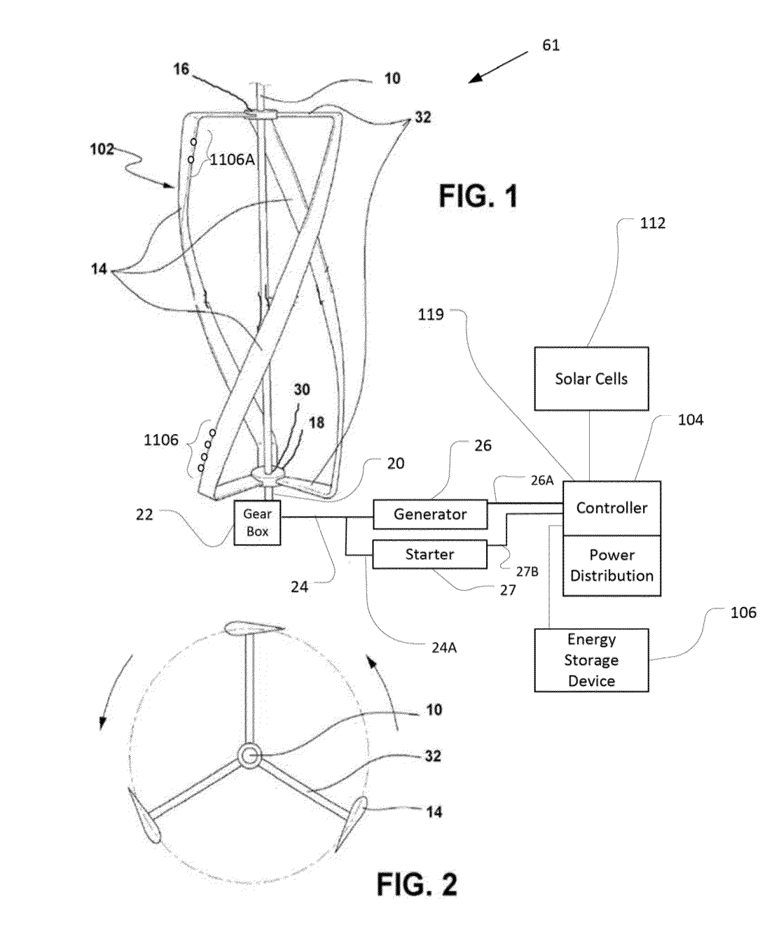

Referring to FIG. 1 there is shown a pictorial illustration of a hybrid energy system 61 including hybrid vertical-axis wind turbine (VAWT) 102 with “twisted” blades 14 incorporating features of the present invention. This VAWT includes a rotor tower 10 that extends mainly vertically, with a center line that defines an axis of rotation 12 for the turbine 101. The height of the rotor tower 10 may be varied and chosen according to the criteria used to determine the height of conventional VAWT designs.

The upper and lower ends of each of a plurality of rotor blades 14 are attached to the rotor tower 10 to an upper hub 16 and a lower hub 18 via supports 32. The blades 14 are connected to or linked with to a driving shaft (not shown) contained within a tower base 20. The driving shaft transmits torque from the rotating blades via a gearbox 22 to a shaft 24 of an electrical generator 26. Electrical generator 26 is connectable to integrated controller 104 having embedded power distribution via power cable 26A.

The rotor tower 10 preferably forms or is rigidly connected to the internal shaft that extends into the gearbox 22, whereby the rotor tower 10 will rotate along with the blades 14. Other arrangements are also possible in which the rotor tower is stationary and other shafts and linkages are provided to transmit the torque from the blades to the generator shaft. It will be understood that any conventional transmission system for the generator 26 can be used. For example, depending on the generator and the degree of torque reduction required, the rotating shaft (which may be the rotor tower 10) could be connected directly to the generator shaft 24.

Still referring to FIG. 1 there is shown starter 27 connectable to controller 104 via power cable 27B. Starter 27 provides driving force to gear box 22 via shaft linkage 24A and generator shaft 24.

The rotor tower 10 and the blades 14 may be made of an materials that have sufficient resistance to fatigue even when subject to long-term periodic loading at the RPMs at which the turbine is expected to operate (which will depend on the expected wind strength and regularity at the turbine site, on the mechanical and electrical properties of the gearbox 22 and generator 26, etc.)

In a preferred embodiment described herein the blade 14 construction includes a honeycomb core covered with a functionally graded material (FGM), such as, for example, a bamboo laminate. As will be described herein the honeycomb core covered with a bamboo laminate advantageously provides a vertical axis wind turbine blade in which deformations of the blade are prevented or minimized and wherein the blade structure is strengthened without increasing. the overall weight while at the same time providing as natural and aesthetically pleasing structure. It will be appreciated that the FGM may be any suitable material occurring in nature or man-made.

Still referring to FIG. 1, battery 106 may be any suitable rechargeable battery connectable to turbine 102 via integrated controller 104 having embedded power distribution. Solar receptor cells 112 may be any suitable solar cells connectable to an energy storage device 106 such as, for example, a rechargeable battery, via integrated controller 104. Furthermore, energy storage device may be any suitable energy storage device or devices (e.g., electrical, mechanical, or chemical), such as for example, an electro-chemical capacitive energy storage device, or a kinetic energy storage device. It will be appreciated that integrated controller 104 is suitably configured to adapt alternating current (AC) voltages and direct current (DC) voltages as input or output voltages.

Still referring to FIG. 1, integrated controller 104 also includes power monitoring and control logic and resources to select a power source (e.g., solar cells 112 or wind turbine 102) to charge energy storage device 106. Integrated controller also includes power sensing logic and resources necessary to prevent energy storage device 106 from overcharge or undercharge conditions. It will be appreciated that power sources (solar cells 112 and wind turbine 102) may operate independently to substantially simultaneously charge one or more energy storage devices.

Referring also to FIG. 2 there is shown a top down view of the blade/hub configuration in the VAWT according to the invention shown in FIG. 1. Blades 14 are shaped according to a suitable airfoil shape in accordance with the National Advisory Committee for Aeronautics (NACA).

A prototype using, vertical axis bamboo wind turbine and solar panels in the hybrid energy system 61 includes turbine 102 having diameter of 0.44 m and a height of 0.53 m. A NACA 0018 air foil style is used in a pitch angle of 60 degrees and twist angle of 80 degrees. The helical blade skeletons are produced using a 3D printer with polymeric materials. Moso bamboo fiber laminates are used for blade surfaces, and epoxy is used in a vacuum infusion method to complete the blade design. Sensors 1106A are attached to one or more the 14. Sensors may be any suitable sensor such as, for example, optical, acoustic, ultraviolet, or ultrasound. Also shown are light emitting diodes (LEDs) which may be use to generate dynamic light patterns for aesthetic and/or warning purposes. A microcontroller 119 controls the wind and solar energy harvested via power distribution panel 104.

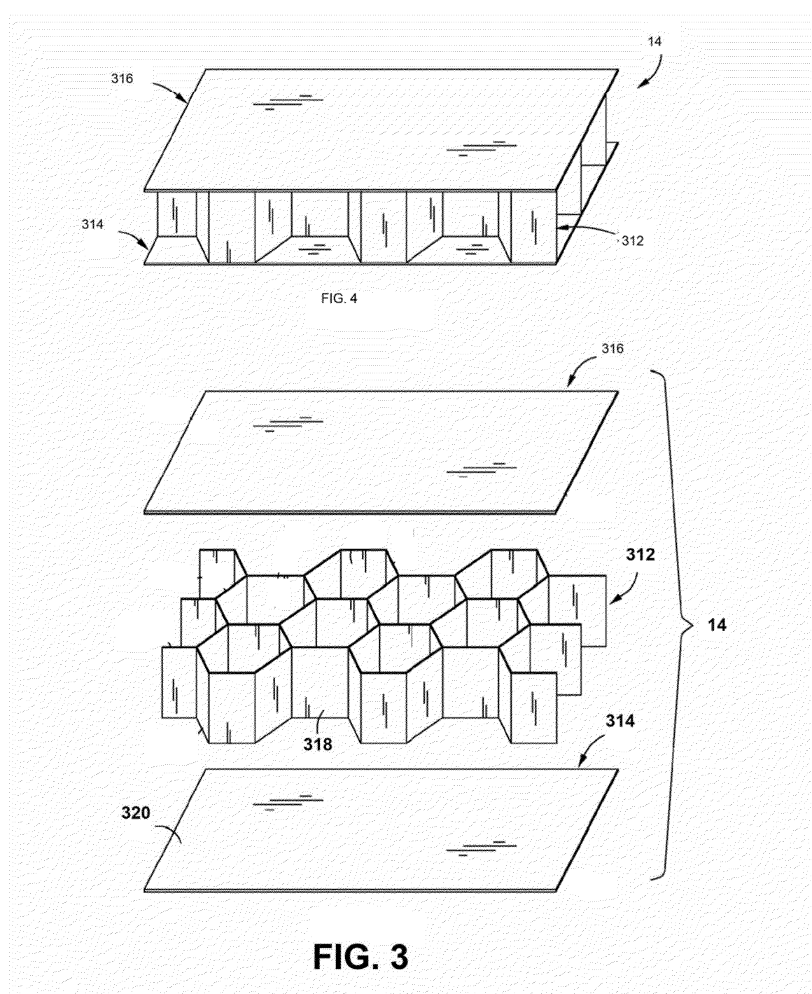

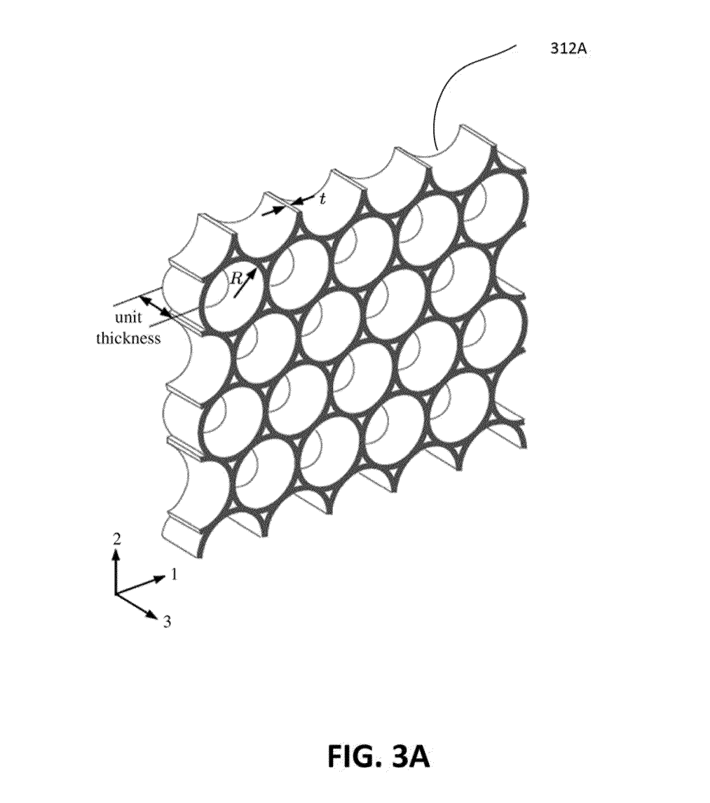

Referring, also to FIG. 3 there is shown a partial exploded view of the twisted blades 14 in accordance with the invention shown in FIG. 1. As shown in FIG. 3, the twisted blades 14 are constructed with a honeycomb core 312 covered with bamboo fiber laminates 314, 316. The bamboo fiber laminates 314, 316 may be adhered to the honeycomb structure by any suitable means such as an epoxy 320. It will be appreciated that the epoxy 320 may be a bio-degradable epoxy, it will also be appreciated that the honeycomb core 312 may be any suitable honeycomb core such as the circular honeycomb core 312A shown in FIG. 3A. Wherein each of the circular honeycombs is defined by a predetermined, unit thickness, a wall diameter ½ t, and a radius R.

The honeycomb core 312 (or 312A) may be any suitable honeycomb core suitable for airfoil shaping, such as, for example, an Acrylonitrile butadiene styrene (ABS) plastic core with fracture reducing holes to reduce or stop traveling stress fractures. The honeycomb core 312 may be constructed of honeycomb walls 318 such as, for example, honeycomb walls produced by a 3D printer perpendicular to the walls 318.

Referring also to FIG. 4, there is shown a partial sectional view of the twisted blades 14 in accordance with the invention shown in FIG. 1. Bamboo fiber laminates 314, 316 may be obtained from bamboo culm using known chemical or mechanical methods.

Depending on the environment in which the wind turbine is installed, erosion from sand and build-up of insects on the blades may be problems. It is therefore possible to construct the blades of more than one material, such as using an aluminum skin on a fiberglass blade body. In areas in which icing is an anticipated problem, it is also possible to provide each blade with a deicing device such as an inflatable bladder running along or near at least part of the leading edge of the blade. In such case, a suitable conventional bladder-inflating system will be provided. Such deicing arrangements are well-known to designers of airplane wings, and are therefore not discussed further here.

In one embodiment in which the rotor tower 10 rotates with the blades 14, the tower 10 is mounted via a bearing 30 in the tower base 20. It is also possible according to the invention to omit the hubs 16, 18 altogether, so that the blades 14 are attached directly to the rotor tower 10, or to attach the blades to the rotor tower using some other structure.

It will be appreciated that the helical skeleton core, combined, with the mechanical features of bamboo, permit thinner, stronger, and flexible blades than blades described in the prior art. It should be understood that the foregoing description is only illustrative of the invention. Accordingly, the present invention is intended to embrace all such alternatives, modifications and variances which fall within the scope of the appended claims.

What is claimed is:

1. A hybrid renewable energy system (HRES), the system comprising:
a vertical-axis wind turbine (VAWT) for harvesting wind energy;
a solar receptor for harvesting solar energy;
at least one energy storage device (ESD) for storing the energy harvested, by the VWAT; and
a controller for controlling the VAWT, the solar receptor, the ESD, wherein the controller comprises:
a power distribution panel for combining and distributing the harvested and stored energy.

2. The HRES as in claim 1, wherein the ESD comprises a rechargeable battery.

3. The HRES as in claim 1, wherein the ESD comprises a capacitive storage device.

4. The FIRES as in claim 1, wherein the ESD comprises a kinetic energy storage device.

5. The HRES as in claim 1, wherein the VAWT comprises:
a plurality of blades, wherein each of the plurality of blades comprise:
a honeycomb core shaped to a predetermined airfoil shape, wherein the honeycomb core comprises:
an upper surface;
a lower surface;
a top laminate fixedly attached to the upper surface;
a bottom laminate fixedly attached to the lower surface; and
wherein the top and bottom laminates are fixedly attached with an epoxy.

6. The HRES as in claim 5 wherein the honeycomb core further comprises walls having front and back faces, wherein the walls are arranged in a honeycomb shape and wherein each wall comprises internal honeycomb shapes perpendicular to the wall faces.

7. The HRES as in claim 6 wherein the honeycomb core comprises ABS plastic.

8. The HRES as in claim 5 wherein the top and bottom laminates comprises a functionally graded material.

9. The HRES as in claim 8 wherein the functionally graded material comprises Bamboo fibers.

10. The HRES as in claim 5 wherein each of the plurality of blades comprise a plurality of light emitting diodes.

11. An aesthetic hybrid renewable energy system (HRES), the AHRES comprising:
a vertical-axis wind turbine (VAWT) for harvesting wind energy
a solar receptor for harvesting solar energy;
at least one energy storage device (ESD) for storing the energy harvested by the VWAT;
a controller for controlling the VAWT, the solar receptor, the ESD, wherein the controller comprises:
a power distribution panel for combining and distributing the harvested and stored energy;
a plurality of blades, wherein each of the plurality of blades comprise:
a honeycomb core shaped to a predetermined airfoil shape, wherein the honeycomb core comprises:
an upper surface;
a lower surface;
a top laminate fixedly attached to the upper surface;
a bottom laminate fixedly attached to the lower surface;
wherein the top and bottom laminates are fixedly attached with a biodegradable epoxy; and
wherein the top and bottom laminates comprise aesthetic Bamboo fibers.

12. The AHRES as in claim 11 wherein at least one of the blades comprise:
a plurality of sensors selected from the group consisting of acoustic sensor, optical sensor, ultrasound sensor, and ultraviolet sensor.

13. The A HRES as in claim 11 further comprising:
a starter;
a controller for controlling the AVAWT, the solar receptor, the ESD, and the power distribution panel, wherein the controller comprises:
a power distribution panel for combining and distributing the harvested and stored energy;
logic and resources for initiating the starter;
logic and resources for selecting the harvested solar energy or the harvested wind energy to charge the ESD; and
a power protection circuit for monitoring the ESD.

14. The AHRES as in claim 11 wherein the ESD comprises a capacitive storage device.

15. The AHRES as in claim 11 wherein the honeycomb core further comprises walls having front and back faces, wherein the walls are arranged in a honeycomb shape and wherein each wall comprises internal honeycomb shapes perpendicular to the wall faces.

16. The HRES as in claim 11 wherein each of the plurality of blades conforms to a National Advisory Committee for Aeronautics (NACA) standard.

17. The AHRES as in claim 11 wherein at least one of the blades comprises a plurality of light emitting diodes (LEDs).

18. An aesthetic vertical-axis wind turbine (AVAWT) for harvesting wind energy, the AVAWT comprising:
a plurality of blades, wherein each of the plurality of blades comprise:
a honeycomb core shaped to a predetermined airfoil shape, wherein the honeycomb core comprises:
an upper surface;
a lower surface;
a top laminate fixedly attached to the upper surface;
a bottom laminate fixedly attached to the lower surface;
wherein the top and bottom laminates are fixedly attached with a biodegradable epoxy; and
wherein the top and bottom laminates comprise a functionally graded material.

19. The AVAWT as in claim 18 wherein the functionally graded material comprises Bamboo fibers.

20. The AVAWT as in claim 18 wherein at least of the plurality of blades comprises a plurality of light emitting diodes (LEDs).
